(19) United States
(12) Patent Application Publication
(10) Pub. No.: US 2012/0207427 A1
(43) Pub. Date: Aug. 16, 2012

(54) OPTICAL MODULE CONNECTION DEVICE

(75) Inventor: Toshiyasu ITO, Tokyo (JP)

(73) Assignee: YAMAICHI ELECTRONICS CO., LTD., Tokyo (JP)

(21) Appl. No.: 13/346,173

(22) Filed: Jan. 9, 2012

(30) Foreign Application Priority Data
Feb. 10, 2011 (JP) 2011-027273

(51) Int. Cl. G02B 6/12

(52) U.S. Cl. 385/14

(57) ABSTRACT

A printed circuit board is pinched between end faces of a metal receptacle support member and a metal backup member in an optical-module plug portion, the flexible wiring board having a light emitting/receiving element unit, a reception chip portion, a driver element, and the like on a common planar surface thereof, such that the end face of the metal receptacle support member is in contact with a surface of the printed circuit board and that the driver element is in contact with the metal backup member.

### CROSS-REFERENCE TO RELATED APPLICATIONS

This application claims the benefit of Japanese Patent Application Nos. 2011-027273 filed Feb. 10, 2011 which is hereby incorporated by reference herein in their entirety.

### BACKGROUND OF THE INVENTION

1. Field of the Invention

The present invention relates to an optical module connection device including an optical-module plug portion to which an optical cable connector is connected.

2. Description of the Related Art

In an optical communication system, when an optical connector and a mother board are connected with each other, photoelectric conversion between an optical signal and an electric signal takes place. In such photoelectric conversion, an optical module is used. The optical module comprises an optical element which is configured to perform interconversion between an optical signal and an electric signal so as to receive and transmit the optical signal through the optical connector, an optical fiber, and the like. A surface light emitting element represented by a VCSEL (vertical cavity surface emitting LASER) in converting an electric signal into an optical signal, is used in the optical module. And a plane light receiving element represented by a PIN photo diode in converting an optical signal into an electric signal is used. These optical elements are electrically connected to the board (mother board) through an optical module connection device. The optical connector, the optical fiber, and the like are connected to the optical module connection device and thereby are optically connected to the optical elements.

As such a connection device for connecting the optical connector and the mother board, a connection device is proposed as shown in Japanese Patent Application Laid-Open No. 2009-163184, for example. In the connection device, an optical connector and a mother board are connected with each other by using an optical module into which the optical connector is inserted and a cage allowing the optical module to be inserted thereinto and removed therefrom. The cage is provided on the mother board. In addition, for example, another type of an optical module is shown in Japanese Patent Application Laid-Open No. 2009-199037. The optical module comprises: an upper structural body which optical waveguides is held by a holding member; and a board loaded with an optical-element/electronic-component, the board optically connected to the upper structural body. The board loaded with optical-element/electronic-component comprises a ceramic substrate. An optical element and electronic components such as a driver integrated circuit device for driving the optical element and the optical element comprising VCSELs which are surface light emitting elements and PIN photo diodes which are plane light receiving elements are mounted on the ceramic substrate. Moreover, in International publication No. WO 2008/096716, still another type of an optical module is shown. The optical module comprises an optical semiconductor element and a semiconductor element on a board flexible enough to bend, the semiconductor element configured to drive the optical semiconductor element and amplify signals of the optical semiconductor element.

It is known that these optical elements and the drive circuits for driving the optical element liberate heat depending on the value of optical output power at a relatively high temperature in action.

### SUMMARY OF THE INVENTION

When an optical module having a surface optical semiconductor element and a drive circuit for driving the optical element is connected with an optical connector and with a cage on a mother board, heat from heating elements such as a driver integrated circuit device and the like is transferred or conducted through an air layer, a wiring board, and the like in the cage. Thus, there is a certain limit in improving heat dissipation efficiency in such an optical module connection device.

In view of the above-described mentioned problem, the present invention aims to provide an optical module connection device including an optical-module plug portion to which a connector for optical cable is connected. The optical module connection device can achieve improvement of heat dissipation efficiency of the optical module connection device.

To achieve the above-described object, an optical module connection device according to the present invention includes an optical-module plug portion including a support member which supports a connection portion to be connected to an optical cable, a backup member which is formed of a metal material and pinches a wiring board having an optical element provided at a position corresponding to the connection portion and at least one drive circuit adjacent to the optical element, in cooperation with an end face of the support member with the backup member being in contact with the wiring board and the drive circuit, and a metal case which is in contact with an outer peripheral surface of the backup member and accommodates the backup member; and a receptacle unit having a socket to which a connection end portion of the wiring board in the optical-module plug portion is connected.

According to an optical module connection device of the present invention, a backup member is formed of a metal material and pinches a wiring board having an optical element at a position corresponding to the connection portion and at least one drive circuit adjacent to the optical element, in cooperation with an end face of the support member in such a manner that the backup member is in contact with the wiring board and the drive circuit . Thus, it is possible to improve the heat dissipation efficiency of the optical module connection device and concurrently can downsize the optical module connection device.

Further features of the present invention will become apparent from the following description of exemplary embodiments (with reference to the attached drawings).

### BRIEF DESCRIPTION OF THE DRAWINGS

FIG. 1 is a cross-sectional view showing a structure of an optical-module plug portion and a receptacle portion in an example of an optical module connection device according to the present invention;

FIG. 2A is a perspective view showing a state in which the optical-module plug portion and the receptacle portion are connected with each other in the example of the optical module connection device according to the present invention;

FIG. 2B is a perspective view showing a state in which the optical-module plug portion is not connected with the receptacle portion in the example shown in FIG. 2A;

FIG. 3 is an exploded perspective view showing, in parts, a structure of the optical-module plug portion in the example of the optical module connection device according to the present invention;

FIG. 4 is a cross-sectional view showing the structure of the optical-module plug portion shown in FIG. 3;

FIG. 5A is a perspective view showing an optical-module main-body portion in the optical-module plug portion shown in FIG. 3;

FIGS. 5B and 5C are perspective views made available for explaining assembling of the optical-module main-body portion shown in FIG. 5A;

FIG. 6 is a perspective view showing, in parts, a structure of the optical-module main-body portion in the optical-module plug portion shown in FIG. 3;

FIG. 7A is a perspective view showing a flexible wiring board used in the optical-module plug portion shown in FIG. 3;

FIG. 7B is a perspective view showing a state in which a protective cap is removed from the flexible wiring board shown in FIG. 7A; and

FIG. 8 is a perspective view showing the receptacle portion with a heat sink removed therefrom in the example shown in FIG. 2B.

### DESCRIPTION OF THE EMBODIMENTS

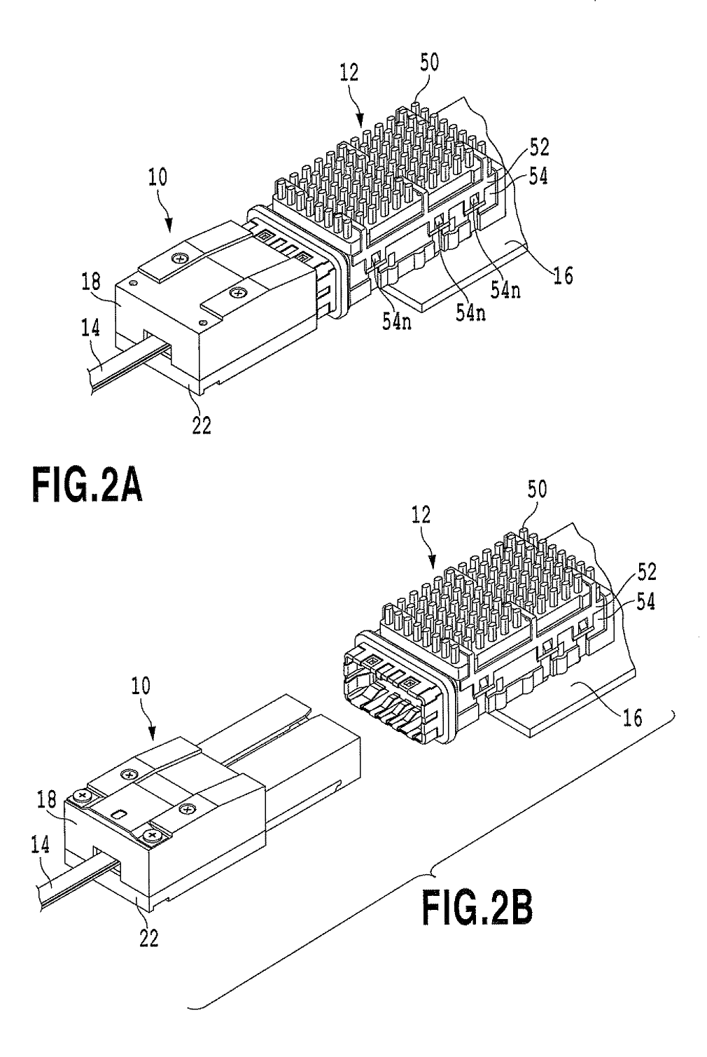

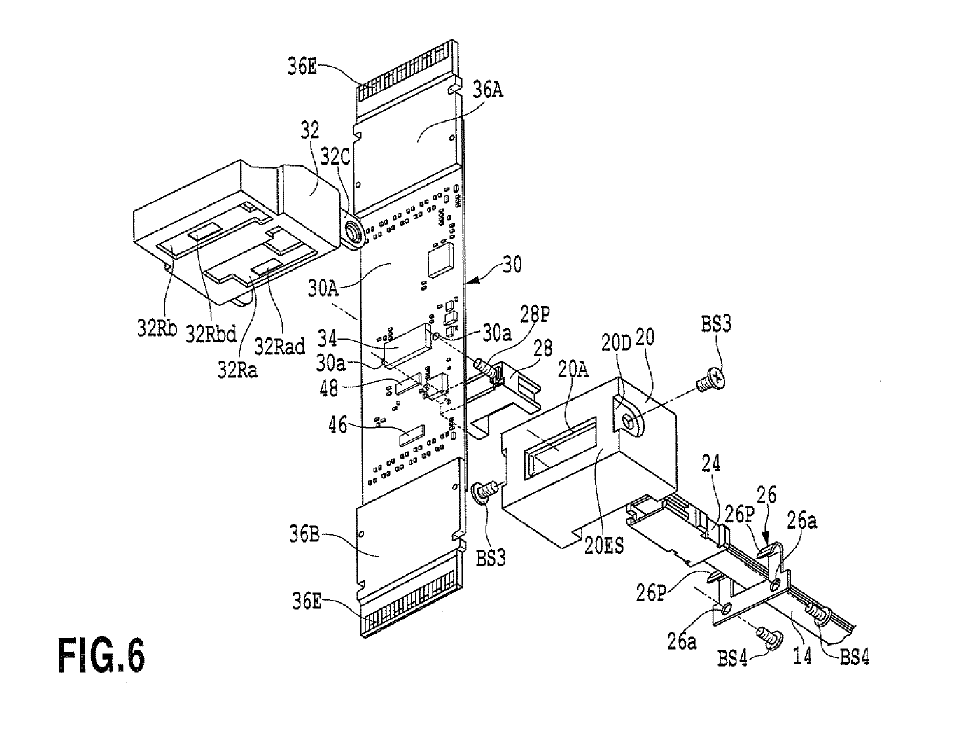

In FIGS. 2A and 2B, the optical module connection device according to an example of the present invention includes as main elements: an optical-module plug portion 10 to which an SF connector 24 (see FIG. 6) connected to one end of an optical fiber cable 14 as an optical cable is attachably and detachably connected; and a receptacle unit 12 to which the optical-module plug portion 10 is connected.

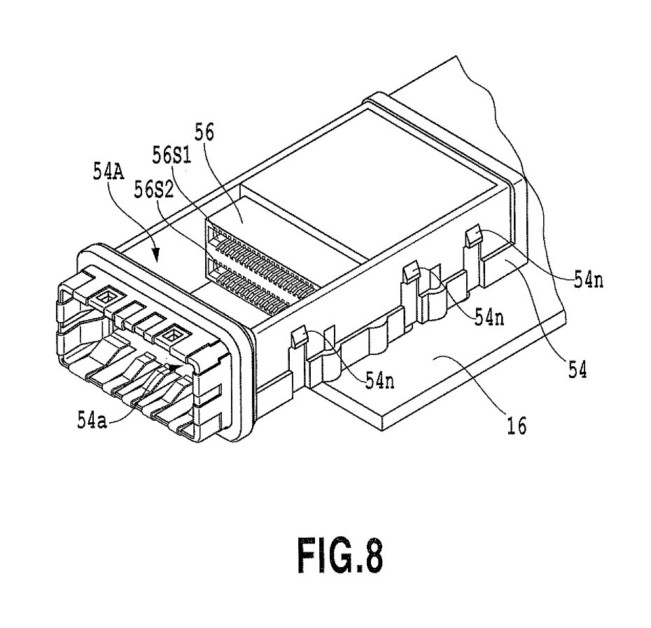

The receptacle unit 12 is fixed on a printed wiring board 16 in the given electronic equipment. The receptacle unit 12 includes a shield case 54 forming a contour portion of the receptacle unit 12, a socket 56 (see FIG. 8) placed in a socket-accommodating portion 54A formed in the shield case 54, and a heat sink 50 covering the top of the shield case 54.

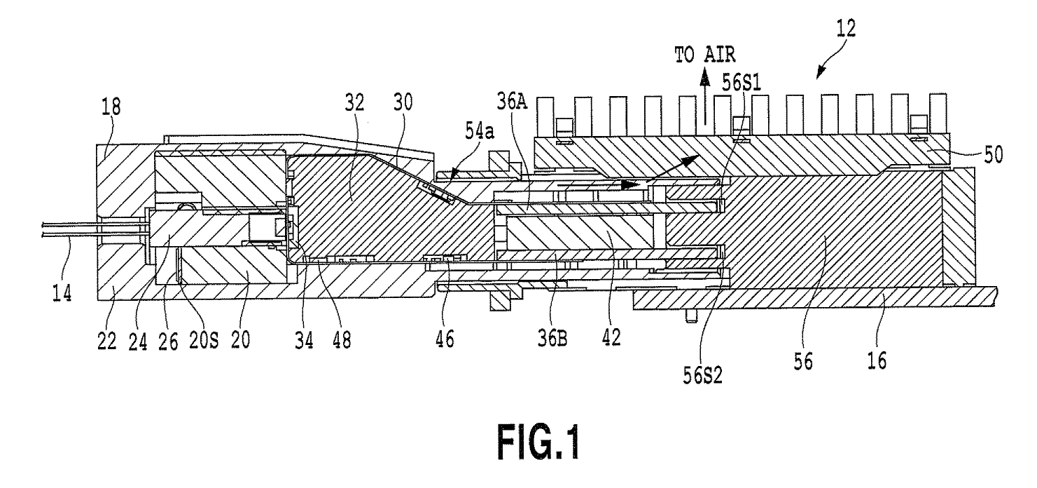

The shield case 54 is made of a metal material and has the socket-accommodating portion 54A therein, as enlarged in FIG. 8. A plurality of nib portions 54n for attaching linking pieces of a heat sink fixture 52 to be described later are formed on opposite sidewalls (FIG. 8 shows only one of the sidewalls) of outer periphery of the shield case 54.

Where the heat sink 50 is removed from the shield case 54, the socket-accommodating portion 54A is opened upward and communicates with a plug insertion opening 54a provided on one side of the shield case 54. A space into which an end portion of the optical-module plug portion 10 to be described later is inserted is formed between one end of the socket 56 in the socket-accommodating portion 54A and one end of the plug insertion opening 54a, as shown in FIG. 1.

In an end portion opposed to the plug insertion opening 54a of the socket 56, two slits 56S1 and 56S2 are formed one above the other and substantially in parallel with each other at a certain interval in a vertical direction with respect to a surface of the printed wiring board 16. Connection boards 36A and 36B of the optical-module plug portion 10 are inserted into the slits 56S1 and 56S2, respectively. A plurality of contact terminals corresponding to contact pads of the connection boards 36A and 36B are arranged in multiple fine grooves formed in the peripheral edges of the slits 56S1 and 56S2. Fixed terminal portions of these contact terminals are fixed by soldering onto a conductive pattern (not shown) in the printed wiring board 16. Herewith, when the connection boards 36A and 36B of the optical-module plug portion 10 are inserted into the slits 56S1 and 56S2 to be connected therewith as enlarged in FIG. 1, each of the connection boards 36A and 36B is electrically connected to the conductive pattern (not shown) in the printed wiring board 16 through the plurality of contact terminals.

As shown in FIG. 2A, the heat sink 50 is molded of, for example, an aluminum alloy and has multiple heat dissipation pins arranged vertically and horizontally in an upper end portion thereof. The heat sink fixture 52 for fixing the heat sink 50 onto the shield case 54 has three gate-shaped strip pieces and linking pieces for connecting each end portions of three strip pieces one another. The strip piece is in contact with an upper surface of the heat sink 50, between adjacent dissipation pin rows and passes therebetween. The linking piece of the strip pieces is formed in such a manner as to extend along a long side of the heat sink 50 and has three holes at predetermined intervals, the holes being attached with the nib portions 54n of the shield case 54. Each holes of the linking pieces of the heat sink fixture 52 are attached with the nib portions 54n of the shield case 54, as shown in FIG. 2A. Thereby, the heat sink 50 placed on the upper end of the shield case 54 is fixed onto the shield case 54.

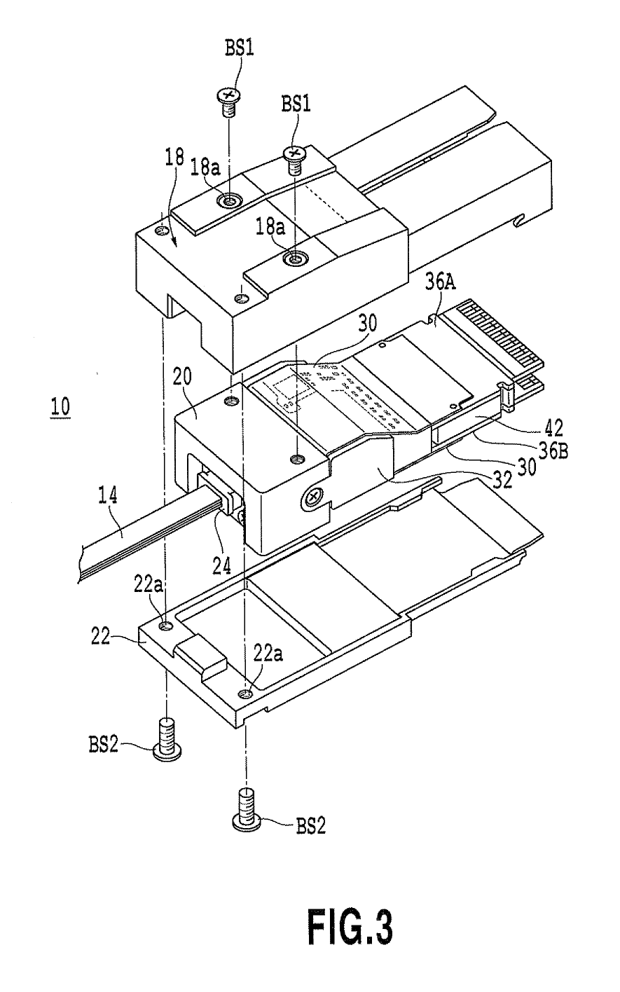

As shown in FIG. 3, the optical-module plug portion 10 includes an optical-module main-body portion; an upper case 18 covering an upper portion of the optical-module main-body portion; and a lower case 22 covering a lower portion of the optical-module main-body portion.

The upper case 18 is molded of, for example, a metal material having a good thermal conductivity and has a recessed portion accommodating the upper portion of the optical-module main-body portion. In an upper wall portion forming the recessed portion, two through-holes 18a communicating with the recessed portion are formed at a certain interval. Machine screws BS1 for fixing the upper case 18 onto the optical-module main-body portion are inserted into the through-holes 18a, respectively.

The lower case 22 is molded of, for example, a metal material having a good thermal conductivity and has a relatively shallow recessed portion accommodating the lower portion of the optical-module main-body portion. Two through-holes 22a are formed in one end portion of the lower case 22. Machine screws BS2 for fixing the lower case 22 onto the optical-module main-body portion are inserted into the through-holes 22a, respectively.

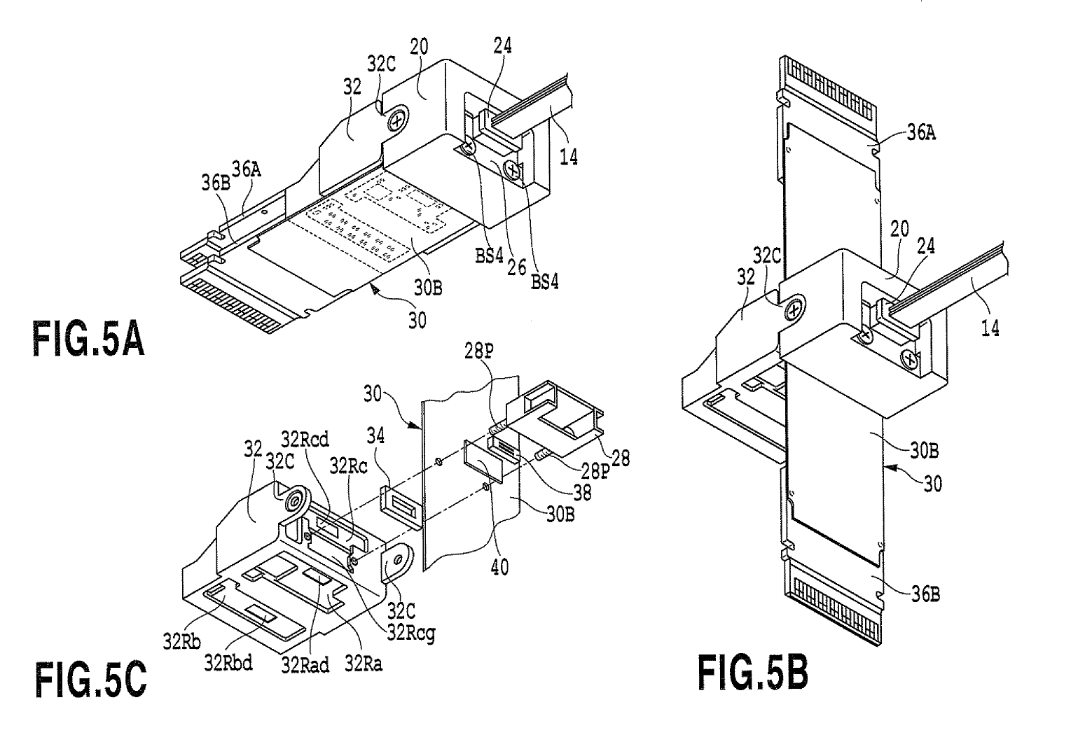

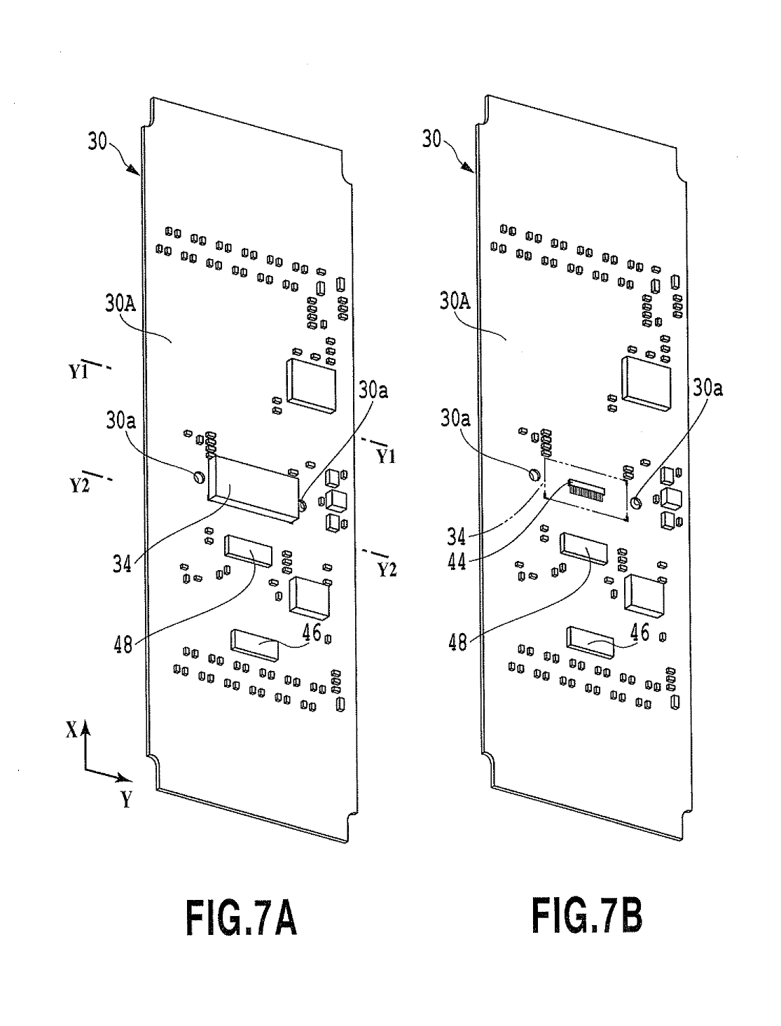

As shown in FIGS. 5A and 6, the optical-module main-body portion includes as main elements: a receptacle support member 20 accommodating therein and supporting a receptacle 28 to which the SF connector 24 is connected; a flexible printed circuit board 30 on which a light emitter/photodetector unit 44 to be described later (see FIG. 7B) and the like are mounted; and a stiffener 32 for positioning and holding a protective cap 34 to be described later at a predetermined position while the protective cap 34 is in contact with a surface 30A of the flexible printed circuit board 30.

The receptacle support member 20 has an opening portion 20A into which the receptacle 28 is inserted. The opening portion 20A extends through the receptacle support member 20 in a direction of connection and disconnection with the SF connector 24. One end portion of the opening portion 20A is opened in an end face 20ES of the receptacle support member 20. The end face 20ES is in contact with a surface 308 of the flexible printed circuit board 30.

In addition, a fixing face 20S (see FIG. 1) is formed along a peripheral edge of the other end portion of the opening portion 20A from which an end portion of the SF connector 24 is exposed, as shown in FIG. 5A. A rebound leaf 26 is fixed onto the fixing face 20S. Two female screw holes into which two machine screws BS4 for fixing the rebound leaf 26 onto the receptacle support member 20 are inserted, respectively are formed in the fixing face 20S. Further, as shown in FIG. 6, recesses 20D are formed in portions of respective opposite side face portions of the receptacle support member 20, the portions being adjacent to the end face 20ES. Coupling portions 32C of the stiffener 32 to be described later are inserted into the recesses 20D, respectively. Female screw holes into which machine screws BS3 are inserted through holes in the coupling portions 32C, respectively, are formed in the recesses 20D.

The receptacle 28 has a pair of positioning pins 28P on one end portion thereof, the positioning pins 28P being respectively inserted into given through-holes 30a in the flexible printed circuit board 30 to be described later and corresponding holes in the stiffener 32. In addition, an opening portion (not shown) in which a microhole formation member 38 to be described later is fitted is formed in the one end portion of the receptacle 28.

The microhole formation member 38 can be positioned and held with respect to the SF connector 24 and a thin glass plate 40 of the flexible printed circuit board 30 (see FIG. 5C) by the peripheral edge of the opening portion. The microhole formation member 38 has microholes corresponding to element wires comprising the optical fiber cable 14 to be described later. Further, the receptacle 28 has fitting holes in which the SF connector 24 is fitted.

The optical fiber cable 14 connected to the SF connector 24 at one end is, for example, a multichannel optical fiber cable.

The SF connector 24 has shoulder portions on opposite side portions thereof, the shoulder portions being engaged with a pair of pressing pieces 26P of the rebound leaf 26, respectively. Hereby, as a result of the fact that the machine screws BS4 are screwed into the female screw holes of the receptacle support member 20 through holes 26a of the rebound leaf 26 as shown in FIG. 5A, the SF connector 24 accompanied by the optical fiber cable 14 is fixed onto the receptacle support member 20 while the SF connector 24 is pressed against the microhole formation member 38 and the glass plate 40. At this time, the element wiring group comprising the optical fiber cable 14 is pressed against a surface of the microhole formation member 38 at a force of about 1 kg.

As shown in FIGS. 6, 7A, and 7B, the flexible printed circuit board 30 having flexibility has the connection boards 36A and 36B on opposite ends thereof. Since the connection boards 36A and 36B have the same structure, a description is given of the connection board 36A, and a description of the connection board 36B is omitted.

The connection board 36A has a contact pad group 368 on opposite surfaces thereof at one end, the contact pad group 368 comprising multiple contact pads formed in parallel with one another at a predetermined interval. Meanwhile, the connection board 36A is electrically connected to the conductive pattern formed in the flexible printed circuit board 30 at the other end. The one end and the other end of the connection board 36A are electrically connected with each other through a conductor formed inside the connection board 36A.

The flexible printed circuit board 30 is a wiring board having flexibility in which wirings of a conductor such as copper are formed in one or both of surfaces of an insulative base material such as polyimide, polyester, or liquid crystal polymers.

As shown in FIGS. 7A and 78, the light emitter/photodetector unit 44 is mounted on the one surface 30A of the flexible printed circuit board 30 at a substantially center portion of the surface 30A. The light emitter/photodetector unit 44 is covered with the rectangular protective cap 34 made of glass. The through-holes 30a into which the aforementioned positioning pins 28P are inserted are respectively formed at the sides of short sides of the protective cap 34. A reception chip portion 46 and a driver element 48 comprising a part of a drive circuit as a heating element are mounted on the flexible printed circuit board 30 at a position adjacent to the light emitter/photodetector unit 44 in a direction of an X-coordinate axis of the Cartesian coordinates shown in FIG. 7A.

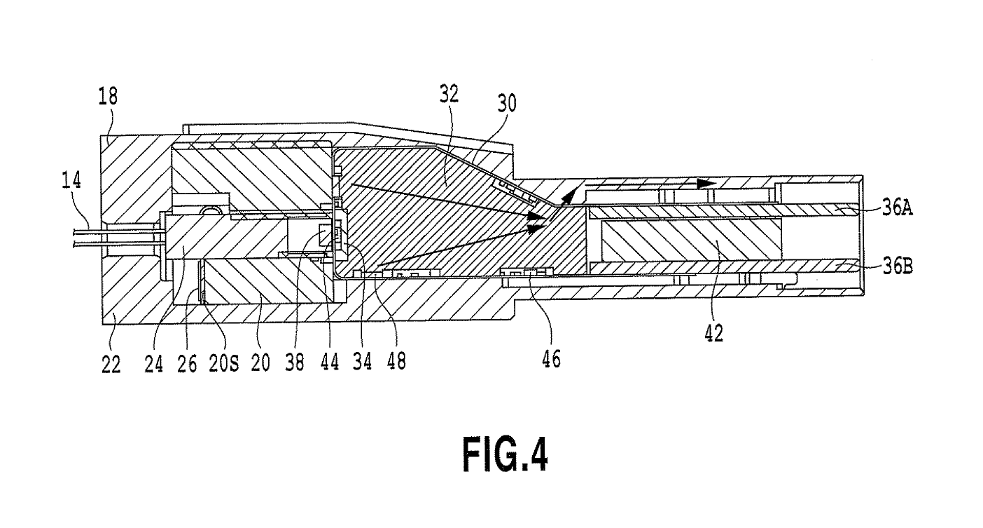

In addition, a portion located between the connection board 36A and the connection board 36B of the flexible printed circuit board 30 can be bent as shown in FIG. 4 along chain double-dashed lines Y1, Y2 along a Y-coordinate axis in FIG. 7A, and are fixed onto a lower face portion, a back face portion, and an upper face portion of the stiffener 32. The chain double-dashed line Y2 cuts across between the protective cap 34 and the driver element 48, while the chain double-dashed line Y1 cuts across a predetermined distance away from the protective cap 34.

The stiffener 32 is molded of, for example, a metal material having a good thermal conductivity. An outer peripheral portion of the stiffener 32 has: the back face portion with which protective cap 34 of the aforementioned flexible printed circuit board 30 is in contact; the lower face portion with which the driver element 48 and the reception chip portion 46 of the flexible printed circuit board 30 are in contact; and the upper face portion opposed to the lower face portion.

As shown in FIG. 6, relatively shallow recessed portions 32Ra and 32Rb which are adjacent to each other at a predetermined interval are formed in the lower face portion. A recess 32Rad accommodating the driver element 48 is formed in the recessed portion 32Ra. The driver element 48 is accommodated with a peripheral surface thereof in close contact with a wall portion forming the recess 32Rad. In addition, a recess 32Rbd accommodating the reception chip portion 46 is formed in the recessed portion 32Rb. The reception chip portion 46 is accommodated with a peripheral surface thereof in close contact with a wall portion forming the recess 32Rbd.

As enlarged in FIG. 5C, a recessed portion 32Rcg accommodating the protective cap 34 is formed in the back face portion. In addition, the coupling portions 32C protrude respectively on opposite ends of the back face portion. The coupling portions 32C have the through-holes into which the machine screws BS3 are inserted. Hereby, the coupling portions 320 are inserted into the recesses 200 of the receptacle support member 20, and thereafter the machine screws BS3 are screwed into the recesses 20D through the through-holes. Thereby, the flexible printed circuit board 30 accompanied by the driver element 48 and the like are pinched between the end faces of the receptacle support member 20 and the stiffener 32. At that time, the pinching results in a state where the end face 20ES of the receptacle support member 20 is in contact with the surface 30B and where the driver element 48 is in contact with the stiffener 32. In addition, the flexible printed circuit board 30 is bent along the aforementioned chain doubled-dashed lines Y1 and Y2.

In assembling the optical-module main-body portion having the aforementioned configuration, the receptacle support member 20 accommodating the receptacle 28 and the stiffener 32 are firstly coupled with each other by screwing the machine screws BS3 into the through-holes of the coupling portions 32C via the flexible printed circuit board 30. At this time, the protective cap 34 mounted on the one surface 30A of the flexible printed circuit board 30 is positioned with respect to the recessed portion 32Rcg of the back face portion of the stiffener 32. In addition, the pair of positioning pins 28P are inserted into the respective through-holes 30a of the flexible printed circuit board 30 and the holes of the stiffener 32. Thereby, relative positioning between the light emitter/photodetector unit 44 and the microhole formation member 38 is done. Next, as shown in FIG. 5A, the portion located between the connection board 36A and the connection board 36B of the flexible printed circuit board 30 is bent in such a manner as to be in close contact with the upper face portion, the back face portion, and the lower face portion of the stiffener 32. At this time, the driver element 48 and the reception chip portion 46 are positioned with respect to the recess 32Rad and the recess 32Rbd, respectively. In addition, a spacer member 42 is sandwiched between the connection board 36A and the connection board 36B. Thereby, as shown in FIG. 4, the connection boards 36A and 36B are arranged in parallel at a predetermined distance spaced away from each other. And, as described above, the SF connector 24 is fixed onto the receptacle support member 20 with the rebound leaf 26 and the machine screws BS4. Thereafter, the aforementioned upper case 18 is fixed onto the receptacle support member 20 of the optical-module main-body portion with the machine screws BS1, and the lower case 22 is fixed onto the upper case 18 with the machine screws BS2.

Thus, when the reception chip portion 46 and the driver element 48 are in an operation state, most of heat generated from the reception chip portion 46 and the driver element 48 is efficiently conducted to tip end portions of the upper case 18 and the lower case 22 through the stiffener 32 made of metal, as shown by the arrow in FIG. 4.

Further, for example, where the optical-module plug portion 10 is connected to the receptacle unit 12 as shown in FIG. 2A and the reception chip portion 46 and the driver element 48 are in the operation state, most of the heat generated from the reception chip portion 46 and the driver element 48 is efficiently conducted in a direction shown by the arrow shown in FIG. 1 through the stiffener 32 made of metal and the tip end portion of the upper case 18 all of which are made of metal.

The heat is also efficiently dissipated to the air through the heat sink 50 due to the heat transmission. At this time, the tip end portion of the upper case 18 and a lower surface of the heat sink 50 are in contact with each other. Further, since the heat is dissipated to the air also through the stiffener 32, the upper case 18, and the lower case 22, the heat sink 50 can be downsized.

While the present invention has been discussed with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is

1. An optical module connection device comprising:
an optical-module plug portion including a support member which supports a connection portion to be connected to an optical cable, a backup member which is formed of a metal material and pinches a printed circuitboard having an optical element provided at a position corresponding to the connection portion and at least one drive circuit adjacent to the optical element, in cooperation with an end face of the support member with the backup member being in contact with the printed circuit board and the drive circuit, and a metal case which is in contact with an outer peripheral surface of the backup member and accommodates the backup member; and
a receptacle unit having a socket to which a connection end portion of the printed circuit board in the optical-module plug portion is connected.

2. The optical module connection device according to claim 1, wherein the connection portion to be connected to the optical cable is supported by the support member with the connection portion being urged toward the optical element by a resilient member.

3. The optical module connection device according to claim 2, wherein the receptacle unit comprises a heat sink which is in contact with an outer peripheral portion of the metal case of the optical-module plug portion when the receptacle unit is connected with the optical-module plug portion.

4. The optical module connection device according to claim 1, wherein the backup member comprises a recess accommodating the drive circuit.

5. The optical module connection device according to claim 1, wherein
the printed circuit board is a flexible wiring board having connection boards on opposite ends thereof and having the drive circuit between the connection boards, and
the flexible wiring board is bent in such a manner that the connection boards face each other at a distance when the flexible wiring board is arranged on the outer peripheral surface of the backup member.

6. The optical module connection device according to claim 5, wherein the support member has a pair of positioning pins on one end portion thereof, the positioning pins being inserted respectively into holes in the backup member through a pair of through-holes in the flexible wiring board.

7. The optical module connection device according to claim 5, wherein the backup member has a recessed portion in an end face thereof facing the flexible wiring board, the recessed portion accommodating a protective cap covering the optical element on the flexible wiring board.
